(19) United States
(12) Patent Application Publication
(10) Pub. No.: US 2009/0214805 A1
(43) Pub. Date: Aug. 27, 2009

(54) INKJET RECORDING MEDIUM

(75) Inventor: Masamichi KOBAYASHI, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/389,770

(22) Filed: Feb. 20, 2009

(30) Foreign Application Priority Data
Feb. 26, 2008 (JP) 2008-044835

(51) Int. Cl. B41M 5/50

(52) U.S. Cl. 428/32.17

(57) ABSTRACT

An inkjet recording medium is provided. The inkjet recording medium includes: a resin-coated paper in which both sides of base paper are coated with a polyolefin resin; a first porous layer disposed as an uppermost layer positioned farthest from the resin-coated paper, the first porous layer containing silica and a cationic polymer containing an aromatic ring; and at least one second porous layer disposed between the first porous layer and the resin-coated paper, the at least one second porous layer containing silica, a water-soluble aluminum compound and a sulfur-containing compound, and the content of a cationic polymer containing an aromatic ring in the at least one second porous layer being no more than 4% by mass relative to the silica in the at least one second porous layer.

### CROSS-REFERENCE TO RELATED APPLICATION

This application claims priority under 35 USC 119 from Japanese Patent Application No. 2008-044835, the disclosure of which is incorporated by reference herein.

### BACKGROUND OF THE INVENTION

1. Field of the Invention

The present invention relates to an inkjet recording medium which has a multilayered structure.

2. Description of the Related Art

In recent years, a variety of information processing systems have been developed together with rapid advancements in the information technology industry, and recording methods and recording instruments suitable for these information processing systems have also been developed and put into practical use. Among these, an inkjet recording method has seen widespread, in view of advantages such as a capability of recording on a variety of recording materials, relatively inexpensive and compact hardware (apparatus), and excellent quietness. Further, it has become possible to obtain high quality recorded materials, including photo-like recorded materials, when using the inkjet recording method.

Characteristics that are demanded for a recording medium for inkjet recording include, in general, (1) quick-drying properties (a high degree of ink absorption rate); (2) an adequate and uniform ink dot diameter (generating no bleeding); (3) favorable graininess; (4) a high degree of circularity of dots; (5) a high degree of color density; (6) a high degree of color saturation (being dullness-free); (7) excellent light resistance, ozone resistance, and water resistance of a printing area; (8) a high degree of whiteness; (9) favorable storability of a recorded medium (no yellowing or discoloration even during long periods of storage, and no image bleeding even during long periods of storage; (10) favorable dimensional stability with favorable resistance to deformation (small amount of curling); and (11) favorable traveling performance in hardware.

In view of the above, recently, recording materials which have an ink-receiving layer having a porous structure have been put into practical use. It is said that such a recording material is excellent in quick-drying and by using such a recording material high glossiness may be obtained. When the recording layer has a porous structure, however, the ozone-resistance of the image is susceptible to become lower. Further, there is a trend that high quality recorded images are always demanded, and further, recorded images free from color changes, such as color tone changes, are demanded.

In connection with the above, from the viewpoint of preventing color-fading or discoloration of images, a method in which a polyvalent metal salt or a cationic polymer has been known. A method in which a solfonic acid or an organic cationic polymer is used in a recording layer has been published (see, for Example, Japanese Patent Application Laid-Open (JP-A) Nos. 2006-187884 and 2006-187885).

### SUMMARY OF THE INVENTION

However, although it is likely that a certain measure of success will be achieved in prevention of color-fading and discoloration of images after recording when a cationic polymer is used, changes in color tone of a neutral color such as a gray tone which occur over time after recording (from several minutes to about 24 hours under average humidity and temperature conditions such as 23° C./60% RH) cannot be prevented and, further, no technique whereby ozone resistance (particularly of cyan) is also achieved has been established.

The present invention has been made in view of the above circumstances and provides an inkjet recording medium.

The present inventor has found that in order to suppress the phenomena whereby a neutral color tone such as a gray tone gradually changes over time, it is particularly effective to utilize a layered structure in which functions are separated or, to be more specific, a layered structure in which a hydrophobic cationic polymer is present in the outermost layer that the ink provided from an external source contacts first, while another layer is endowed with ozone resistance. In particular, since the hue of a neutral color tone such as a gray tone is formed by mixing plural colors, the color balance is disrupted even by small changes in color, which significantly affects the image quality in multi-colored images. The present invention has been accomplished on the basis of this finding.

According to a first aspect of the invention, an inkjet recording medium is provided. The inkjet recording medium, includes: a resin-coated paper in which both sides of a base paper are coated with a polyolefin resin; a first porous layer disposed as an uppermost layer that is positioned farthest from the resin-coated paper, the first porous layer containing silica and a cationic polymer containing an aromatic ring; and at least one second porous layer disposed between the first porous layer and the resin-coated paper, the at least one second porous layer containing silica, a water-soluble aluminum compound and a sulfur-containing compound, and the content of a cationic polymer containing an aromatic ring in the at least one second porous layer being no more than 4% by mass relative to the silica contained in the at least one second porous layer.

### DETAILED DESCRIPTION OF THE INVENTION

Hereinafter, the inkjet recording medium of the present invention will be described in detail.

The inkjet recording medium of the invention includes a resin-coated paper in which both sides of a base paper are coated with a polyolefin resin as a support, and on the resin-coated paper, two or more porous layers including a first porous layer disposed as the uppermost layer that is positioned farthest from the resin-coated paper and at least one second porous layer disposed between the first porous layer and the resin-coated paper.

In the inkjet recording medium of the invention, a hydrophobic cationic polymer is present in the silica-containing porous uppermost layer (an outermost layer from the resin-coated paper) and, at the same time, a water-soluble aluminum compound and a sulfur-containing compound are present in a silica-containing porous layer located below the uppermost layer so as to separate the function for each layer, whereby it is possible to balance both suppression of color-fading and discoloration and maintenance of a high color density. As a result, a neutral color tone such as gray tone where the hue is apt to change within short time after printing may be retained and, in addition, color-fading by ozone may be prevented whereby images in good hue may be retained for a long period of time.

### —Resin-Coated Paper—

The inkjet recording medium of the invention includes a resin-coated paper as a support. The resin-coated paper includes a base paper provided with a polyolefin resin in a film shape on both sides of the base paper.

The base paper is manufactured using wood pulp as a main material together, if necessary, with synthetic pulp such as polypropylene or synthetic fiber such as nylon or polyester in addition to the wood pulp. As the wood pulp, although any of LBKP, LBSP, NBKP, NBSP, LDP, NDP, LUKP and NUKP may be used, it is preferred to use much amount of LBKP, NBSP, LBSP, NDP or LDP containing abundant short fiber. The ratio of LBSP and/or LDP is preferred to be 10 to 70%.

As the pulp, chemical pulp (such as sulfate pulp or sulfite pulp) containing less impurities is preferably used and the pulp where degree of whiteness is enhanced by subjecting to a bleaching treatment is also useful.

To the base paper, it is also possible to appropriately add any of a sizing agent such as a higher fatty acid or a ketene dimer, a white pigment such as calcium carbonate, talc or titanium oxide, a paper strength agent such as starch, polyacrylamide or polyvinyl alcohol, a fluorescent whitener, a moisture retaining agent such as polyethylene glycol, a dispersing agent, a softener such as quaternary ammonium, and the like.

The water freeness of the pulp used for the manufacture of the paper is preferred to be 200 to 500 ml according to the stipulation of CSF, the disclosure of which is incorporated by reference herein, and, with regard to fiber length after beating, the sum of a 24-mesh residue and a 42-mesh residue stipulated by JIS P 8207, the disclosure of which is incorporated by reference herein, is preferred to be 30 to 70%. A 4-mesh residue is preferred to be no more than 20%.

The basis weight of the base paper is preferably 50 to 250 g and, particularly preferably, 70 to 200 g. Thickness of the base paper is preferably 50 to 210 μm.

It is also possible to give high flatness and smoothness to the base paper by subjecting to a calendar treatment during or after the manufacture of the paper. The density of the paper may be usually 0.7 to 1.2 g/m² (JIS P 8118, the disclosure of which is incorporated by reference herein). The rigidity of the paper under the condition stipulated by JIS P 8143, the disclosure of which is incorporated by reference herein, is preferred to be 20 to 200 g.

A surface sizing agent may be applied onto the surface of the base paper. As to the surface sizing agent in that case, the same sizing agent which may be added to the base paper may be used.

The pH of the base paper measured by a hot water extraction method stipulated by JIS P 8113, the disclosure of which is incorporated by reference herein, is preferred to be 5 to 9.

The polyolefin resin which coats both sides of the base paper will be described. Examples of the polyolefin resin include polyethylene, polypropylene and polyisobutylene. Among them, polyethylene is particularly preferred.

As to the polyethylene which coats a face side and a back side of the base paper, although low-density polyethylene (LDPE) and/or high-density polyethylene (HDPE) are/or usually preferred, others such as LLPDE or polypropylene may be used.

Particularly, the polyolefin resin which is provided at the side where porous layer is formed (for example, by coating) of the paper preferably include rutile or anatase-type titanium oxide, whereby opacity and whiteness degree are improved. Amount of titanium oxide to the polyolefin is preferably about 1 to 20% and, more preferably, 2 to 15%.

In order to adjust a white background, a fluorescent whitener or a coloring pigment having high heat resistance may be added to a polyolefin resin.

Examples of the coloring pigment include ultramarine blue, Prussian blue, cobalt blue, phthalocyanine blue, manganese blue, cerulean, tungsten blue, molybdenum blue and anthraquinone blue.

Examples of the fluorescent whitener include dialkylaminocoumalin, bisdimethylaminostilbene, bismethylaminostilbene, 4-alkoxy-1,8-naphthalenedicarboxylic acid N-alkylimide, bisbenzoxazolylethylene and dialkylstilbene.

The amount of polyethylene formed on the front and the back surfaces of the base paper is selected in such a manner that thickness of the porous layer and curl under low and high humidity after installation of a back layer, for example, are optimized. Usually, thickness of the polyethylene formed on the base paper is preferably 15 to 50 μm on the side where the porous layer is formed while, on the side opposite to the side where the porous layer is formed, a range of 10 to 40 μm is preferred. Ratio of the amounts of polyethylene in the front and the back sides of the base paper is preferred to be set so as to adjust generation of curl depending upon type and thickness of the porous layer, thickness of the base paper, etc. and, usually, the ratio of the polyethylene amounts in front/back is about from 3/1 to 1/3 in terms of thickness.

The resin-coated paper where both sides of the base paper are coated with polyethylene is preferred to have the following characteristics (a) to (h).

(a) Tensile strength: 19.6 to 294 N in a longitudinal direction and 9.8 to 196 N in a transverse direction in terms of the strength stipulated by JIS P 8113, the disclosure of which is incorporated by reference herein.

(b) Tear strength: 0.20 to 2.94 N in a longitudinal direction and 0.098 to 2.45 N in a transverse direction in terms of the strength stipulated by JIS P 8116, the disclosure of which is incorporated by reference herein.

(c) Compressive elastic modulus: 9.8 kN/cm²

(d) Opacity: not less than 80% or, particularly, 85 to 98% when measured by a method stipulated by JIS P 8138, the disclosure of which is incorporated by reference herein.

(e) Whiteness (L*, a* and b* stipulated by JIS Z 8727, the disclosure of which is incorporated by reference herein): L*=80 to 96, a*=−3 to +5, b*=−7 to +2

(f) Clark degree of rigidity (Clark degree of rigidity in a conveying direction of an inkjet recording medium): 50 to 300 cm³/100

(g) Moisture in the base paper is 4 to 10% with respect to the medium paper

(h) Degree of glossiness on the side where a porous layer is formed (degree of glossiness of 75-degree mirror) is 10 to 90%.

### —First Porous Layer—

The first porous layer included in the inkjet recording medium of the invention is an uppermost porous layer which is most remote from the resin-coated paper and contains at least silica and a cationic polymer containing an aromatic ring. If necessary, the first porous layer may further contain other components.

(Silica)

The first porous layer in the invention contains at least one type of silica. Since silica is contained therein, it is possible to attain favorable glossiness, ink-absorbing property and image density. Examples of the silica include gas-phased silica and colloidal silica. As to the silica, one type may be used solely or two or more types may be used in combinations.

The gas-phase silica is discriminated from the silica by a wet method in a process for production of synthetic silica and is produced by a flame hydrolysis method. To be more specific, a method where silicon tetrachloride is burned together with hydrogen and oxygen has been commonly known. Silane such as methyl trichlorosilane instead of silicon tetrachloride may be used either solely or in a state of being mixed with silicon tetrachloride. As to the gas-phase silica, a commercially available product such as AEROSIL manufactured by Nippon Aerosil Co., Ltd. or QS TYPE manufactured by Tokuyama Corp. may be used.

Gas-phase silica is usually in a form of secondary particles having appropriate gaps as a result of aggregation, and is preferably a product which is prepared in such a manner that a gas-phase silica where average particle size of primary particles is 3 to 50 nm is used and pulverized/dispersed using ultrasonic wave, high-pressure homogenizer, jet grinder of counter collision type or the like until secondary particles of not larger than 500 nm or, preferably, 100 to 400 nm are produced, because of good glossiness and ink-absorbing property.

An average particle size of the primary particles of the gas-phase silica of the invention is preferred to be 3 to 50 nm. When an average particle size of the primary particles of the gas-phase silica is not larger than 50 nm, degree of glossiness is more effectively enhanced. Further, an ink-absorbing speed of the ink-receiving layer becomes more appropriate. Still further, degree of glossiness of the image part is improved and clearer color having a high printing density may be achieved. On the other hand, when the average particle size of the primary particles of the gas-phase silica is 3 nm or more, ink is not too much retained in the ink-receiving layer, generation of oozing and beading may be more effectively suppressed and, even in continuous printing, generation of dirt on the back, etc. of the inkjet recording medium may be suppressed.

An average primary particle size of gas-phase silica is determined as follows. That is, particles dispersed to an extent where primary particle can be determined are observed under an electron microscope, the diameter of circle having the same area as a projected area of each of 100 particles existing in a predetermined area is defined as a primary particle size of the particle, and the average value of the primary particle sizes is determined as the average primary particle size. An average secondary particle size is determined as follows. That is, an ink-receiving layer of the resulting recording material is observed under an electron microscope and the average value of the particle sizes of the dispersed aggregated particles observed is determined.

The colloidal silica may be prepared in such a manner that silicon dioxide prepared by heating and ripening of silica sol produced by a double decomposition of sodium silicate with an acid or the like or by passing through an ion-exchange resin layer is dispersed in water in a colloidal state. An average primary particle size of the colloidal silica is preferably 20 to 80 nm and, more preferably, 20 to 60 nm in view of ink-absorbing property and glossiness of the white paper part.

Examples of the commercially available product of the colloidal silica which may be used include PL-10A, PL-3L, PL-1, etc. manufactured by Fuso Chemical Co., Ltd. and SNOWTEX ST-20, ST-30, ST-40, ST-C, ST-N, ST-20L, ST-O, ST-OL, ST-S, ST-XS, ST-XL, ST-YL, ST-ZL, ST-OZL, ST-UP, ST-OUP, ST-PS-MO, etc. manufactured by Nissan Chemical Industries, Ltd.

Amount of the gas-phase silica in the first porous layer is preferably 3 to 30 g/m², more preferably, 5 to 15 g/m². When the amount of the gas-phase silica is within the above range, a porous substance may be easily produced and ink-absorbing property and glossiness may be ensured.

Particularly when the colloidal silica is used, a high glossiness and a good touch may be achieved while keeping a high ink-absorbing property when the applying amount in terms of solid content is such an amount that can give a thin film of 0.1 to 2 g/m² and, particularly when recording is conducted using a pigment ink, dullness (lowering of glossiness) in the high density area may be improved. The lower limit of the applying amount of the solid content of the colloidal silica is 0.05 g/m². When the applying amount of the solid content of the colloidal silica is more than 0.05 g/m², a high glossiness and a good touch may be ensured. When the colloidal silica is used, the applying amount of solid content of the colloidal silica is more preferably 0.1 to 1.2 g/m².

(Cationic Polymer Containing Aromatic Ring)

The first porous layer in the invention contains at least one type of cationic polymer containing an aromatic ring. Since a hydrophobic cationic polymer is present in the outermost layer, an interaction with the color material (particularly, dye) in the ink supplied from outside easily takes place whereby changes in color over a short time may be suppressed.

There is no particular limitation for the cationic polymer containing an aromatic ring so far as it is a polymer containing an aromatic ring and a cationic group. At least one aromatic ring in a molecule is sufficient although the cationic polymer containing an aromatic ring may contain two or more aromatic rings as well.

The cationic polymer containing an aromatic ring is preferably a cationic polymer having a structural unit represented by the following formula (A) in view of suppression of color change over time.

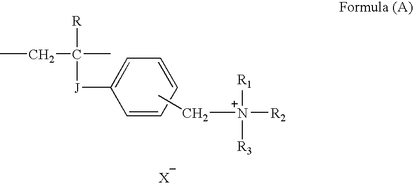

In formula (A), R represents a hydrogen atom or an alkyl group; and R₁, R₂ and R₃ each independently represent an alkyl group or a benzyl group. J is a single bond or a divalent organic group. X⁻ is an anionic group.

In formula (A), an alkyl group represented by R is preferably an alkyl group having 1 to 3 carbon atoms such as a methyl group, an ethyl group or a propyl group and, among them, a methyl group is preferred.

An alkyl group represented by R₁, R₂ and R₃ each independently is preferably an alkyl group having 1 to 6 carbon atoms such as a methyl group, an ethyl group or a propyl group. R₁, R₂ or R₃ is preferably a methyl group, an ethyl group or a benzyl group.

Although there is no particular limitation for the divalent organic group represented by J, it is preferably —CON(R′)—. R′ is a hydrogen atom or an alkyl group. The alkyl group represented by R′ is preferably an alkyl group having 1 to 4 carbon atoms and, more preferably, a methyl group or an ethyl group.

Examples of the anionic group represented by X⁻ include a halogen ion, an acetic acid ion, a methyl sulfuric acid ion and a p-toluenesulfonic acid salt.

A preferred cationic polymer may be a homopolymer including a structural unit represented by formula (A) or may be a copolymer obtained by copolymerizing with another copolymerizable monomer. Examples of the structural unit derived from the copolymerizable monomer include a structural unit derived from a cationic monomer other than formula (A) and a structural unit derived from a monomer having no cationic group.

Examples of the structural unit derived from the cationic monomer having cationic group include the following structural units.

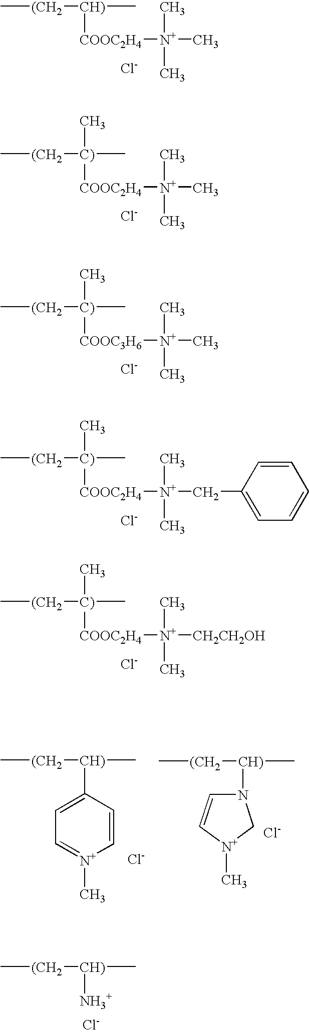

Examples of the structural unit derived from the monomer having no cationic group include a structural unit derived, for example, from ethylene, styrene, butadiene, methyl methacrylate, ethyl methacrylate, propyl methacrylate, butyl methacrylate, octyl methacrylate, methyl acrylate, ethyl acrylate, propyl acrylate, butyl acrylate, octyl acrylate, hydroxyethyl methacrylate, acrylamide, vinyl acetate, vinyl methyl ether, vinyl chloride, 4-vinylpyridine, N-vinylpyrrolidone, N-vinylimidazole, acrylonitrile or the like.

When the cationic polymer containing an aromatic ring has the structural unit represented by formula (A), the ratio of the structural unit represented by formula (A) is preferably not less than 20 molar % and, more preferably, 40 to 100 molar % in view of enhancing the interaction with dye.

Specific examples of the cationic polymer having the structural unit represented by formula (A) are as follows (exemplary compounds P-1 to P-18). However, the invention is not limited thereto.

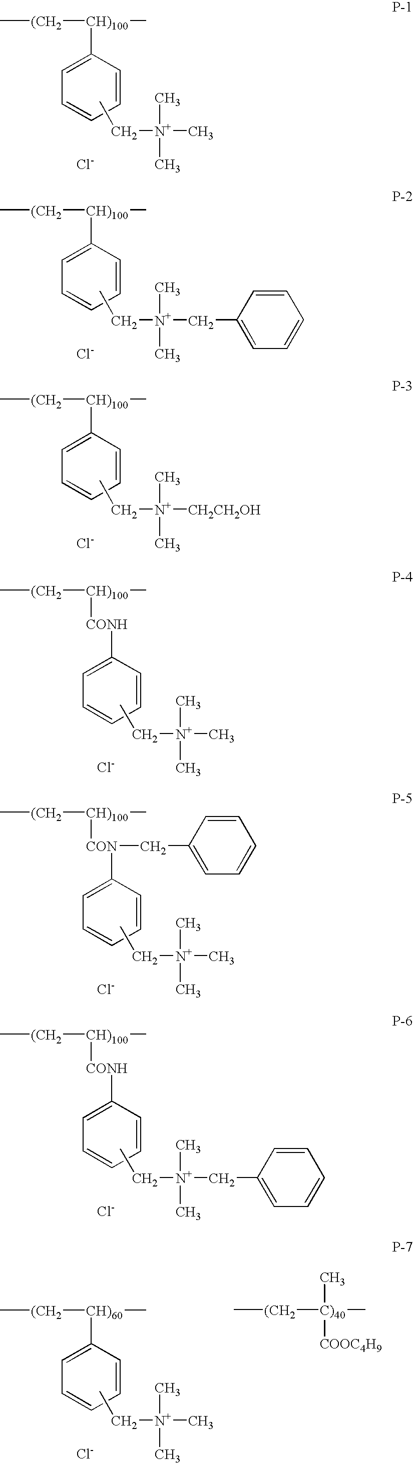

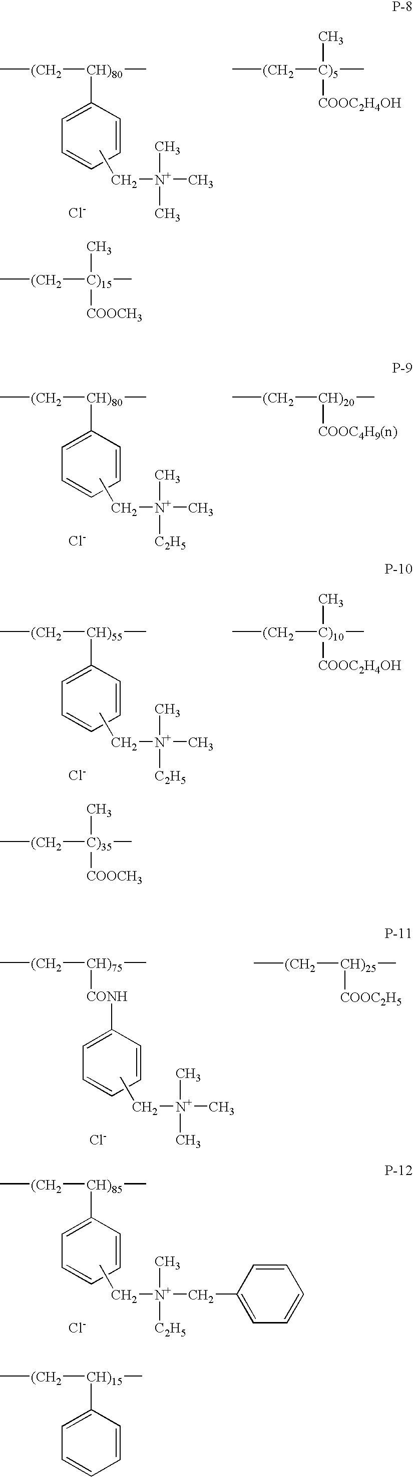

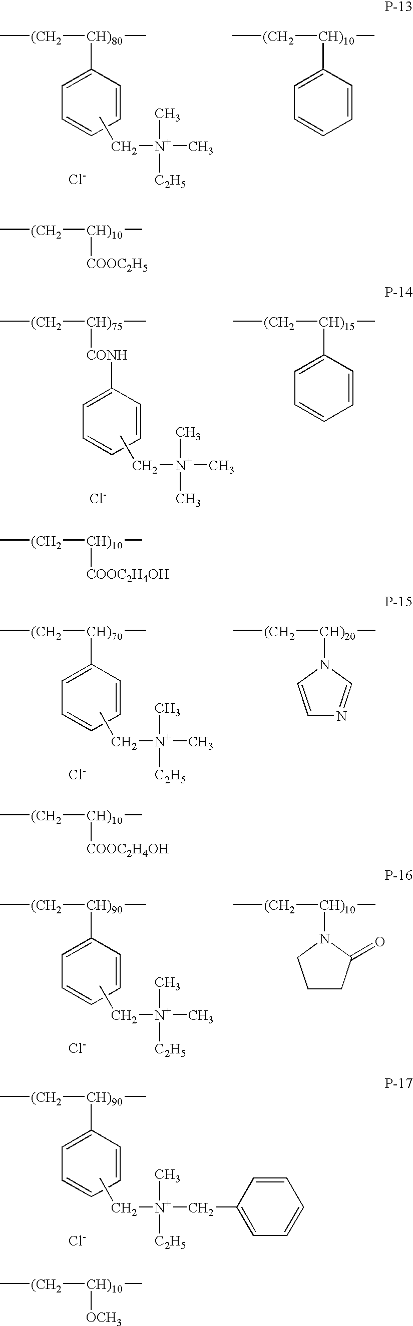

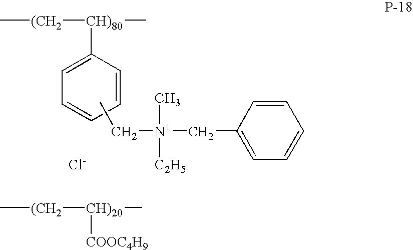

The weight-average molecular weight of the cationic polymer containing an aromatic ring may be about 3,000 to 200,000 and, preferably, 5,000 to 100,000. The weight-average molecular weight is a value based on polyethylene glycol determined by gel permeation chromatography.

The amount of the cationic polymer containing an aromatic ring in the uppermost layer is preferably 0.1 to 2.4 g/m² and, more preferably, 0.2 to 0.8 g/m². When the amount of the cationic polymer containing an aromatic ring is more than 0.1 g/m², color changes in the images over time or, particularly, gradual changes in the color tone where neutral color tone such as gray over time may be effectively suppressed while, when the amount is less than 0.1 g/m², it may be effective in suppressing the lowering in ozone resistance of the dye.

In an exemplary embodiment of the first porous layer of the invention, the silica is gas-phase silica, the cationic polymer containing aromatic ring contains a structural unit represented by formula (A) and, in formula (A), R is methyl, R₁, R₂ and R₃ each independently is a methyl group, an ethyl group or a benzyl group, and J is a single bond or —CONH—.

(Binder)

The first porous layer in the invention may be formed using at least one type of binder. Examples of the binder include hydrophobic and hydrophilic binders. A hydrophilic binder is preferred.

Examples of the hydrophilic binder include gelatin (such as alkali-treated gelatin, acid-treated gelatin or derived gelatin where an amino group is sequestered with phenyl isocyanate, phthalic anhydride or the like), polyvinyl alcohol (an average degree of polymerization and a degree of saponification are preferably 300 to 5,000 and 80 to 99.5%, respectively), polyvinylpyrrolidone, polyethylene oxide, hydroxyethyl cellulose, agar, pullulan, dextrin, acrylic acid, carboxymethyl cellulose, casein and alginic acid.

As to the hydrophilic binder, one type may be used solely or two or more types may be used in combination.

Among the above, a preferred hydrophilic polymer is polyvinyl alcohol (PVA).

Polyvinyl alcohol may be produced by hydrolysis of vinyl acetate. In the invention, polyvinyl alcohol in which the average degree of polymerization is not less than 300 is preferred. Polyvinyl alcohol in which the average degree of polymerization is 1,000 to 5,000 is particularly preferably used. The degree of saponification is preferably 70 to 100% and, particularly preferably, 80 to 99.5%.

In addition to the common polyvinyl alcohol produced by hydrolysis of polyvinyl acetate, examples of polyvinyl alcohol also include a modified polyvinyl alcohol such as polyvinyl alcohol where the terminal is modified with a cation and an anionically modified polyvinyl alcohol having an anionic group.

As to polyvinyl alcohol, two or more types thereof having different degrees of polymerization or of different modified types may be used in combination.

As to the amount of the binder in the first porous layer, it is preferably from about 1.5:1 to 12:1, more preferably from 2:1 to 10:1 and, particularly preferably, from 3:1 to 8:1 in terms of the ratio of inorganic fine powder (p) to binder (b) [the ratio of p:b in mass].

(Cross-Linking Agent)

The first porous layer in the invention may be formed using at least one type of cross-linking agent which cross-links the binder. A cross-linking agent is a compound which cross-links PVA or, in some cases, another binder, and a suitable one in relation to a binder may be appropriately selected. A cross-linking agent may improve the film-forming property in forming the porous layer whereby water resistance of the layer and dot-reproducibility of the ink and the strength may be enhanced.

Examples of the cross-linking agent include boric acid or a salt thereof, an epoxy-type cross-linking agent (such as diglycidyl ethyl ether, ethylene glycol diglycidyl ether, 1,4-butanediol glycidyl ether, 1,6-diglycidyl cyclohexane, N,N-diglycidyl-4-glycidyloxyaniline, sorbitol polyglycidyl ether or glycerol polyglycidyl ether), an aldehyde-type cross-linking agent (such as formaldehyde or glyoxazol), an active halogen-type cross-linking agent (such as 2,4-dichloro-4-hydroxy-1,3,5-s-triazine), an active vinyl-type compound (such as 1,3,5-trisacryloylhexahydro-s-triazine or bisvinylsulfonylmethyl ether), aluminum alum and an isocyanate-type compound. Among the above, boric acid or a salt thereof is preferred.

Boric acid or a salt thereof is an oxygen acid where boron atom is a central atom or a salt thereof. Examples of boric acid or a salt thereof include orthoboric acid, metaboric acid, hypoboric acid, tetraboric acid or pentaboric acid and a salt thereof.

Although the amount of boric acid or a salt thereof in the first porous layer may vary depending upon the amount of silica and binder, the amount of boric acid or a salt there in the first porous layer is preferably about 1 to 60% by mass and, more preferably, 5 to 40% by mass, relative to a binder.

The cross-linking agent such as boric acid or a salt thereof may be added to a coating liquid for forming a porous layer when the coating liquid is applied or may be supplied in such a manner that, after a coating liquid for forming a porous layer containing no cross-linking agent is applied and dried, a solution containing a cross-linking agent is over-coated.

In addition to boric acid or a salt thereof, other cross-linking agent may be used together.

Although the amount of the cross-linking agent in the first porous layer may vary depending upon the type of binder, the type of cross-linking agent, the type of silica, the ratio to a binder, etc., it is preferably 5 to 500 mg and, more preferably, 10 to 300 mg per 1 gram of polyvinyl alcohol when polyvinyl alcohol is used as a binder.

(Solvent)

In preparing a coating liquid for forming a porous layer, solvent is usually used. As the solvent, water, an organic solvent or a mixed solvent thereof may be used. Examples of the organic solvent that may be used for the coating liquid include an alcohol such as methanol, ethanol, n-propanol, isopropanol or methoxypropanol; a ketone such as acetone or methyl ethyl ketone; tetrahydrofuran; acetonitrile; ethyl acetate; and toluene.

(Others)

In addition to the above-mentioned components, other components including various known additives may be used for forming the first porous layer of the invention within such an extent that no advantage of the invention is deteriorated thereby. Examples of other components include an ultraviolet absorber (mentioned, for example, in JP-A Nos. 57-74193, 57-87988 and 62-261476), an anionic, cationic or nonionic surfactant, a fluorescent whitener (mentioned, for example, in JP-A Nos. 59-42993, 59-52689, 62-280069, 61-242871 and 04-219266), an antifoaming agent, a lubricant (such as diethylene glycol), an antiseptic agent, a thickener, an antistatic agent and a matting agent.

### —Second Porous Layer—

The second porous layer included in the inkjet recording medium of the invention is a porous layer disposed between the first porous layer and the resin-coated paper and includes at least a silica, water-soluble aluminum compound and a sulfur-containing compound. If necessary, the second porous layer may further contain other component(s). Moreover, the second porous layer may be configured in any of a single layer and two or more laminated layers.

(Silica)

The second porous layer of the invention contains at least one type of silica. Since it contains silica therein, favorable glossiness, ink-absorbing property and image density may be obtained. Examples of the silica contained in the second porous layer include gas-phase silica and colloidal silica, as in the case of the first porous layer. One type of silica may be used solely or two or more types thereof may be used in combination.

Details of silica such as gas-phase silica or colloidal silica are the same as those mentioned already.

The amount of the silica in the second porous layer is preferably 3 to 30 g/m² and, more preferably, 5 to 15 g/m². When the amount of silica is within the above range, porosity may be easily obtained and ink-absorbing property and glossiness may be ensured.

(Water-Soluble Aluminum Compound)

The second porous layer of the invention contains at least one type of water-soluble aluminum compound. Incorporation of the water-soluble aluminum compound may be effective for the prevention of color-fading of a water-soluble dye caused by ozone gas and, may improve water resistance.

Here, the term “water-soluble” means that the substance dissolves in an amount of not less than 1% by mass in water of 20° C.

Examples of the water-soluble aluminum compound include aluminum chloride or a hydrate thereof, aluminum sulfate or a hydrate thereof, aluminum alum, etc. in the case of an inorganic salt. Further examples thereof include a basic polyaluminum hydroxide compound which is an inorganic aluminum-containing cationic polymer. In view of the ozone resistance of dye, a basic polyaluminum hydroxide compound is particularly preferred.

The basic polyaluminum hydroxide compound means a water-soluble polyaluminum hydroxide the major component of which is represented by the following Formula 1, 2, or 3, and contains stably a basic and high-molecular polynuclear condensation ion such as [Al₆(OH)₁₅]³⁺, [Al₈(OH)₂₀]⁴⁺, [Al₁₃(OH)₃₄]⁵⁺, and [Al₂₁(OH)₆₀]³⁺.

[Al₂(OH)ₙCl₆₋ₙ]ₘ Formula 1

[Al(OH)₃]ₙAlCl₃ Formula 2

Alₙ(OH)ₘCl₍₃ₙ₋ₘ₎ 0<m<3n Formula 3

These compounds are supplied from, for example, from Taimei Chemicals Co., Ltd. under the name of basic polyaluminum chloride (ALUFINE 83), from Tagi Chemical Co., Ltd. under the name of polyaluminum chloride (PAC) as a chemical for water treatment, from Asada Chemical Co., Ltd. under the name of polyaluminum hydroxide (PAHO), from Riken Green Co., Ltd. under the name of PURACHEM WT, and from other manufacturers for the similar purposes. Products of various grades are easily available.

The second porous layer in the invention may be configured such that silica is dispersed using a water-soluble aluminum compound. In that case, as the water-soluble aluminum compound, a polyaluminum hydroxide compound is preferably used, and as the silica, a gas-phase silica is preferably used. Dispersing of silica using a water-soluble aluminum compound is preferred from the viewpoints of improving the ozone resistance and suppressing color changes within a short period after printing.

The amount of the water-soluble aluminum compound in the second porous layer relative to silica is within a range of preferably from 1 to 20% by mass and, more preferably, from 2 to 10% by mass. When the amount of the water-soluble aluminum compound is 1% by mass or more, ozone resistances and water resistance of the dye may become better while, the amount of 20% by mass or less may be advantageous in suppression of decrease in the images density.

(Sulfur-Containing Compound)

The second porous layer of the invention contains at least one type of sulfur-containing compound. The sulfur-containing compound is contained in the second porous layer may contribute in the improvement of ozone resistance of the image. Particularly because the sulfur-containing compound is not contained in the first porous layer but is contained in the second porous layer which is located below the first porous layer, it is possible to enhance the ozone resistance while an effect of suppressing color tone change (color change) of a neutral color such as gray tone may still be highly retained.

Examples of the sulfur-containing compound include a thioether compound and a compound containing a sulfo group (sulfonic acid group) or a sulfoxide group.

The thioether compound may be appropriately selected from thioether compounds which contain one or more thiol groups and examples thereof include 3,6-dithio-1,8-octanediol, bis[2-(2-hydroxyethylthio)ethyl]sulfone, 3,6,9-trithio-1,11-undecanediol, 4-(methylthio)phenol and 2-(phenylthio)ethanol.

Among the thioether compounds, a diol of a terminal OH having 6 to 8 carbon atoms and containing one or more thiol groups is preferred and, for example, 3,6-dithio-1,8-octanediol is preferred.

Examples of the compound containing a sulfo group or a sulfoxide group include sulfonic acid or a salt thereof and a sulfoxide compound and, in view of balancing color change suppression and ozone resistance improvement, sulfonic acid or a salt thereof is preferred.

The sulfonic acid or a salt thereof used in the invention preferably has no optical absorption in a visible region and preferably dissolve in not less than 0.1% by mass in water (23° C.).

Specific examples of a compound preferably used as the sulfonic acid or a salt thereof include methanesulfonic acid, hydroxymethanesulfonic acid, ethanesulfonic acid, 1-propanesulfonic acid, 2-propanesulfonic acid, 1-butanesulfonic acid, 1-pentanesulfonic acid, 1-hexanesulfonic acid, 1-heptanesulfonic acid, 1-octanesulfonic acid, 1-nonanesulfonic acid, 1-decanesulfonic acid, vinylsulfonic acid, 2-methyl-2-propenesulfonic acid, aminomethanesulfonic acid, taurine, 3-amino-1-propanesulfonic acid, sulfoacetic acid, benzenesulfonic acid, 4-ethylbenzenesulfonic acid, 4-chlorobenzenesulfonic acid, p-toluenesulfonic acid, 2-naphthalenesulfonic acid, 1,5-naphthalenedisulfonic acid, trifluoromethanesulfonic acid, styrenesulfonic acid and hydroxybenzenesulfonic acid.

Among the above, particularly preferred ones are methanesulfonic acid, ethanesulfonic acid, benzenesulfonic acid, p-toluenesulfonic acid and 1,5-naphthalenedisulfonic acid.

The compound containing a sulfoxide group (hereinafter, occasionally referred to as a “sulfoxide-containing compound”) preferably has at least one structure represented by the following Formula (1) in the molecule.

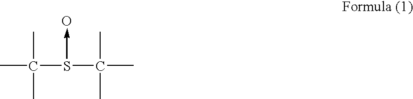

The sulfoxide-containing compound having a structure represented by Formula (1) may be substituted by a hydrophilic group. Examples of the hydrophilic group include substituted or unsubstituted amino groups, substituted or unsubstituted carbamoyl groups, substituted or unsubstituted sulfamoyl groups, substituted or unsubstituted ammonium, hydroxyl group, sulfonic acid, carboxylic acid, phosphoric acid, ethyleneoxy acid, and substituted or unsubstituted nitrogen-containing heterocycles.

Moreover, the sulfoxide-containing compound is preferably a compound represented by the following Formula (2).

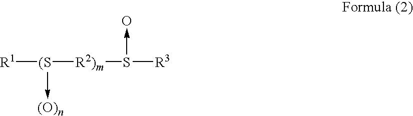

In Formula (2), R¹ and R³ each independently represent a substituted or unsubstituted alkyl group, a substituted or unsubstituted aryl group, a substituted or unsubstituted heterocyclic group, or a polymer residue composed of such groups. R¹ and R³ may be the same as or different from each other. R¹ and R³ may combine with each other to form a ring.

R² represents a substituted or unsubstituted bi- to hexa-valent linking group. R² may combine with R¹ or R² to form a ring, or combine with R² or R³ to form a ring. m is 0 or an integer of 1 or greater. n is 0 or 1. At least one of R¹, R², and R³ represents an alkyl group, an aryl group, a heterocyclic group, or a polymer residue each of which is substituted by a hydrophilic group selected from a substituted or unsubstituted amino group, a substituted or unsubstituted carbamoyl group, a substituted or unsubstituted sulfamoyl group, a substituted or unsubstituted ammonium, a hydroxyl group, a sulfonic acid, a carboxylic acid, a phosphoric acid, an ethyleneoxy group, and a substituted or unsubstituted nitrogen-containing heterocycle.

The unsubstituted alkyl group represented by R¹ or R³ in Formula (2) may have a straight-chain, branched, or cyclic structure, and may contain an unsaturated bond. For example, alkyl groups having 1 to 22 carbon atoms are preferable. Specifically, the alkyl group is preferably a methyl group, an ethyl group, an allyl group, a n-butyl group, a n-hexyl group, a n-octyl group, a benzyl group, an iso-propyl group, an iso-butyl group, a sec-butyl group, a cyclohexyl group, or a 2-ethylhexyl group, more preferably an alkyl group having-1 to 10 carbon atoms, and particularly preferably a methyl group, an ethyl group, an allyl group, a n-propyl group, an iso-butyl group, a cyclohexyl group, or a 2-ethylhexyl group.

The unsubstituted aryl group represented by R¹ or R³ is preferably, for example, an aryl group having 6 to 22 carbon atoms. Specific examples thereof include a phenyl group, a 1-naphthyl group, and a 2-naphthyl group, and a phenyl group is particularly preferable.

Examples of the unsubstituted heterocyclic group represented by R¹ or R³ include a thienyl group, a thiazolyl group, an oxazolyl group, a pyridyl group, a pyrazyl group, a thiadiazoyl group, a triazoyl group, a morphoryl group, a piperazyl group, a pyrimidyl group, a triazyl group, an indolyl group, a benzothiazoyl group, and a benzoxazoyl group; among others, a thiazolyl group, an oxazolyl group, a pyridyl group, a thiadiazoyl group, a triazoyl group, a morphoryl group, a pyrimidyl group, a triazyl group, a benzothiazoyl group, and a benzoxazoyl group are particularly preferred.

When R¹ or R³ represents a polymer residue composed of groups selected from substituted or unsubstituted alkyl groups, aryl groups, and heterocyclic residues, examples of the polymer residue include a polymer having any of the following units.

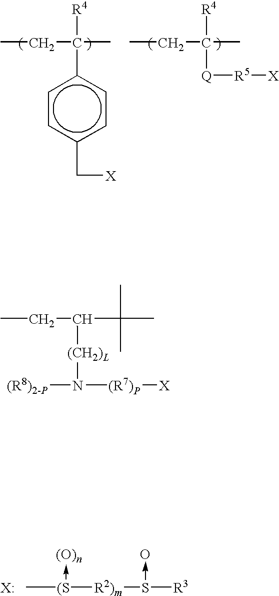

In the above formulae R⁴ represents a hydrogen atom, or an alkyl group having 1 to 4 carbon atoms; R⁵ represents an alkylene group; Q represents a linking group; R⁷ and R⁸ each independently represent an alkylene group; L represents 1 or 2; P represents 1 or 2; R², R³, m, and n have the same definitions as R², R³, m, and n in Formula (2), respectively.

Examples of the linking group represented by Q in the above unit include any of the following linking groups:

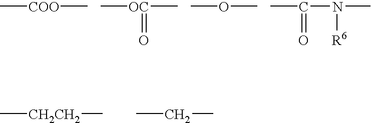

In the above linking groups, R⁶ represents a hydrogen atom, an alkyl group, or an aryl group.

When R¹ or R³ represents a substituted alkyl, aryl, or heterocyclic group, examples of the substituent(s) include substituted or unsubstituted amino groups (e.g. amino groups having 30 or less carbon atoms, an amino group, alkylamino groups, dialkylamino groups, arylamino groups, and acylamino groups); substituted or unsubstituted carbamoyl groups (e.g. carbamoyl groups having 30 or less carbon atoms, a carbamoyl group, a methylcarbamoyl group, a dimethylcarbamoyl group, a morpholinocarbamoyl group, and a piperidinocarbamoyl group); substituted or unsubstituted ammoniums (e.g. ammoniums having 30 or less carbon atoms, ammonium, trimethylammonium, triethylammonium, dimethylbenzylammonium, and hydroxyethyldimethylammonium); substituted or unsubstituted sulfamoyl groups (e.g. sulfamoyl groups having 30 or less carbon atoms, a sulfamoyl group, a methylsulfamoyl group, a dimethylsulfamoyl group, a morpholinosulfamoyl group, and a piperidinosulfamoyl group); substituted or unsubstituted nitrogen-containing heterocycles (e.g. a pyridyl group, a pyrimidyl group, a morpholino group, a pyrrolidino group, a piperidino group, and a piperazyl group); hydrophilic groups represented by a hydroxyl group, a sulfonic acid, a carboxylic acid, a phosphoric acid, an ethyleneoxy group and the like; a cyano group; halogen atoms (e.g. a fluorine atom, a chlorine atom, and a bromine atom); substituted or unsubstituted alkoxycarbonyl groups (e.g. alkoxycarbonyl groups having 30 or less carbon atoms, a methoxycarbonyl group, an ethoxycarbonyl group, a dimethylaminoethoxyethoxycarbonyl group, a diethylaminoethoxycarbonyl group, and a hydroxyethoxycarbonyl group); substituted or unsubstituted aryloxycarbonyl groups (e.g. aryloxycarbonyl groups having 30 or less carbon atoms, and a phenoxycarbonyl group); substituted or unsubstituted alkoxy groups (e.g. alkoxy groups having 30 or less carbon atoms, a methoxy group, an ethoxy group, a phenoxyethoxy group, a buthoxyethoxy group, and a hydroxyethoxy group); substituted or unsubstituted aryloxy groups (e.g. aryloxy groups having 30 or less carbon atoms, and a phenoxy group); substituted or unsubstituted acyloxy groups (e.g. acyloxy groups having 30 or less carbon atoms, an acetyloxy group, and a propionyloxy group); and substituted or unsubstituted acyl groups (e.g. acyl groups having 30 or less carbon atoms, an acetyl group, and a propionyl group).

R¹ and R³ may be the same as or different from each other, and may combine with each other to form a ring.

R² represents a substituted or unsubstituted divalent to hexavalent linking group. R² may be bonded to R¹ or R², or R² or R³ to form a ring. Examples of the sulfur-containing heterocycle formed by such a bonding include a thienyl group, a thiazoyl group, a thiazolidyl group, a dithiolan-2-yl group, a trithian-2-yl group, and a dithian-2-yl group.

Examples of the divalent to hexavalent linking group represented by R² include those containing carbon, nitrogen, oxygen, or phosphor; and a specific examples thereof include the following linking groups.

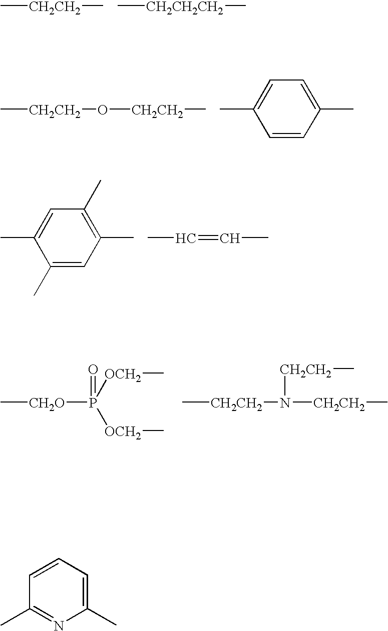

These linking groups may contain a hetero bond such as an ether bond, an ester bond, an amino bond, an amide bond, or a urethane bond, and may have a substituent. A polymer composed of a repetition of linking groups selected from the above may also be used, in which the respective linking groups may be the same as or different from each other.

At least one of R¹, R², and R³ represents an alkyl group, an aryl group, a heterocyclic group, or a polymer residue each of which is substituted by a hydrophilic group represented by a substituted or unsubstituted amino group, a substituted or unsubstituted carbamoyl group, a substituted or unsubstituted sulfamoyl group, a substituted or unsubstituted ammonium, a hydroxyl group, a sulfonic acid, a carboxylic acid, a phosphoric acid, an ethyleneoxy group, or a substituted or unsubstituted nitrogen-containing heterocycle. The hydrophilic group may be selected from the substituents mentioned in the description of R¹ and R³.

When the preparation of the inkjet recording medium of the invention involves practically aqueous coating, the sulfoxide-containing compound according to the invention is preferably water-soluble. Such a sulfoxide-containing compound is a Lewis base, which has higher solubility in water than a thioether compound. Therefore, the sulfoxide-containing compound can be added in a larger amount than a thioether compound.

When the sulfoxide-containing compound according to the invention is water-soluble, it is preferred to add the sulfoxide-containing compound to a coating liquid or basic solution containing the after-mentioned fine particles and water-soluble resin.

When the sulfoxide-containing compound according to the invention is oil-soluble, it is preferred to add the sulfoxide-containing compound to the coating liquid or basic solution containing fine particles and a water-soluble resin after the sulfoxide-containing compound is emulsified or after the sulfoxide-containing compound is added to an organic solvent.

In the inkjet recording medium, the content of the sulfoxide-containing compound is preferably 0.01 to 20 g/m², and more preferably 0.05 to 7 g/m² in view of further improvement in ozone resistance, resistance to bleeding (image bleeding), and glossiness.

In the inkjet recording medium, the sulfoxide-containing compound, which generally has a higher oxidation potential than conventional sulfur-containing compounds (thioethers, thioureas), can achieve higher ozone resistance and higher light resistance when combined with a superior colorant having a high oxidation potential for the sake of improving the ozone resistance and the light resistance.

Only a single sulfoxide-containing compound according to the invention may be used, or two or more sulfoxide-containing compounds according to the invention may be used in combination.

Specific examples (exemplary compounds A-1 to A-75) of the sulfoxide-containing compound will be shown below, but the invention is not limited thereto.

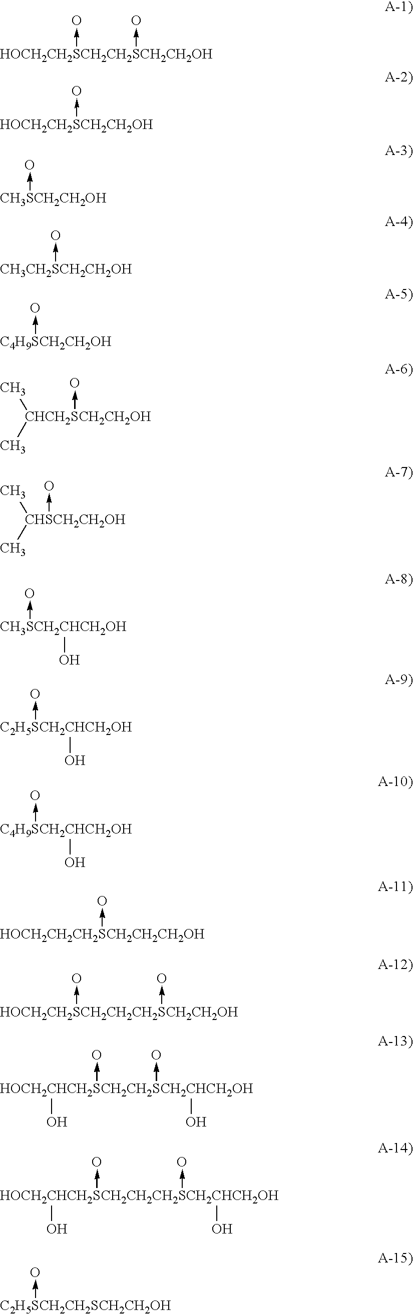

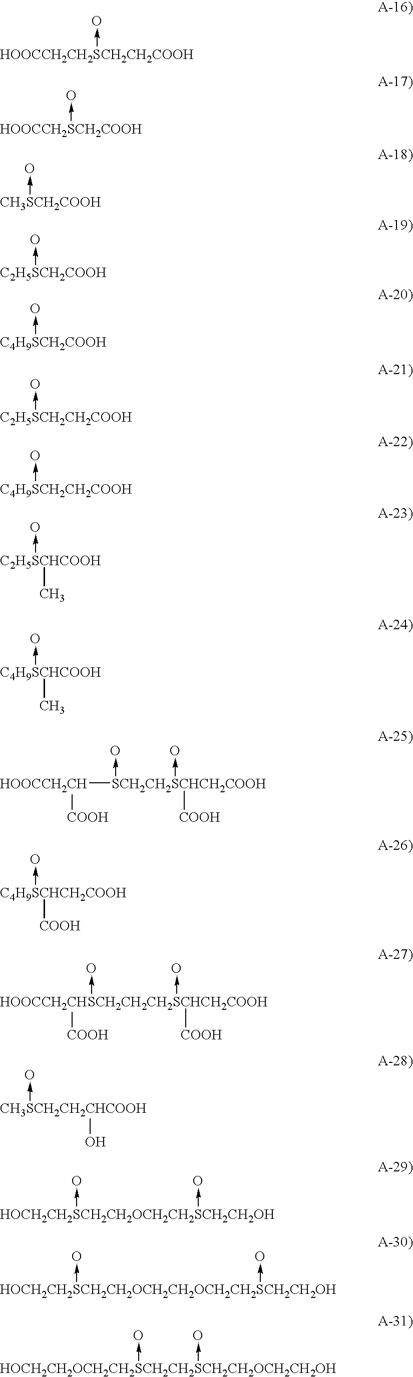

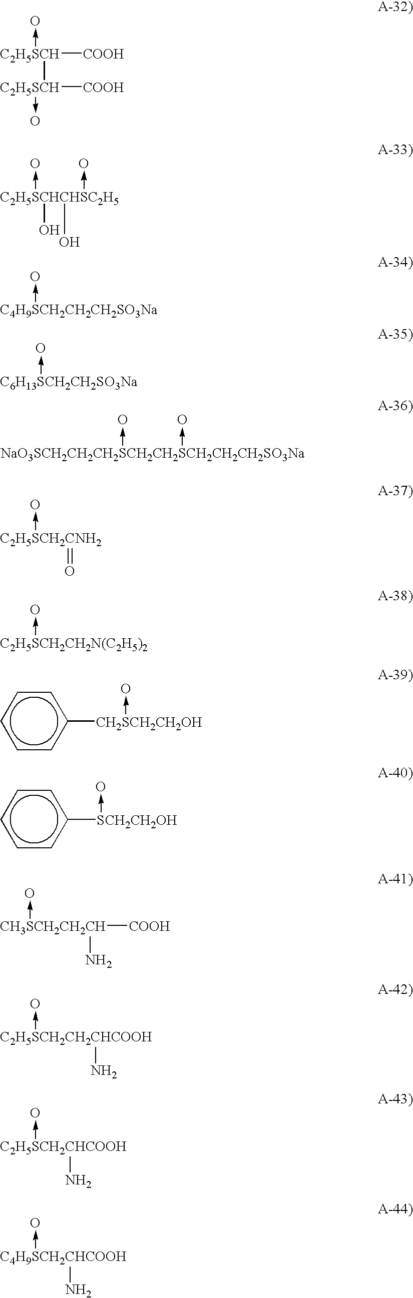

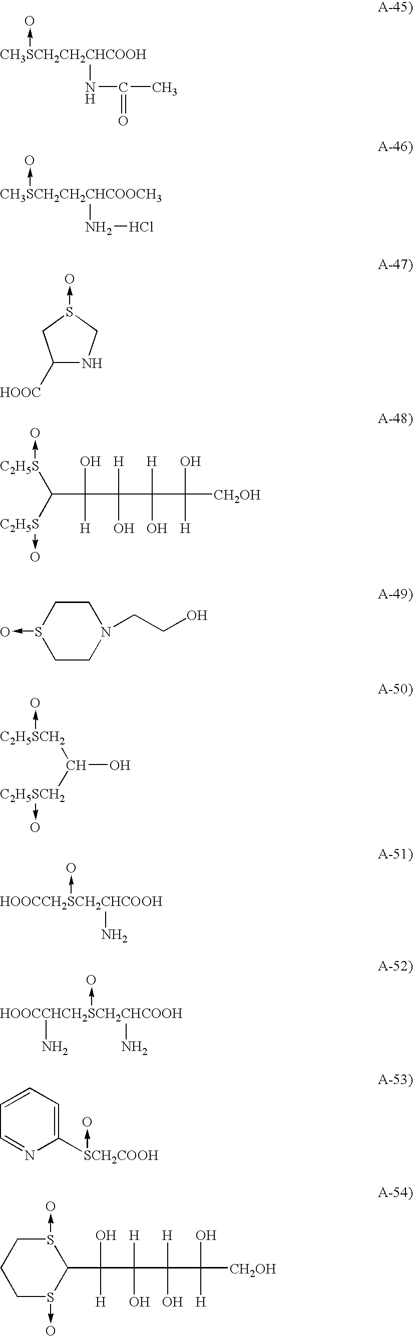

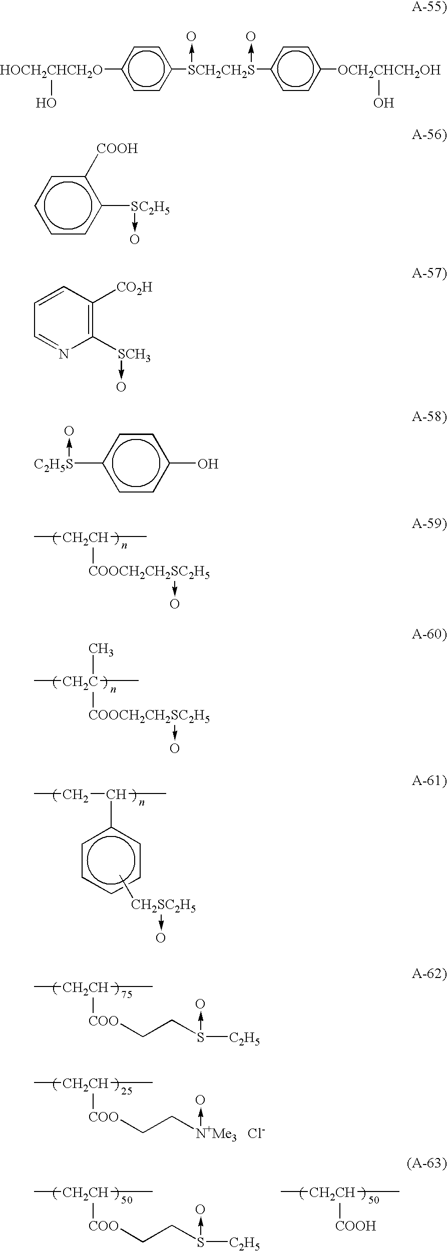

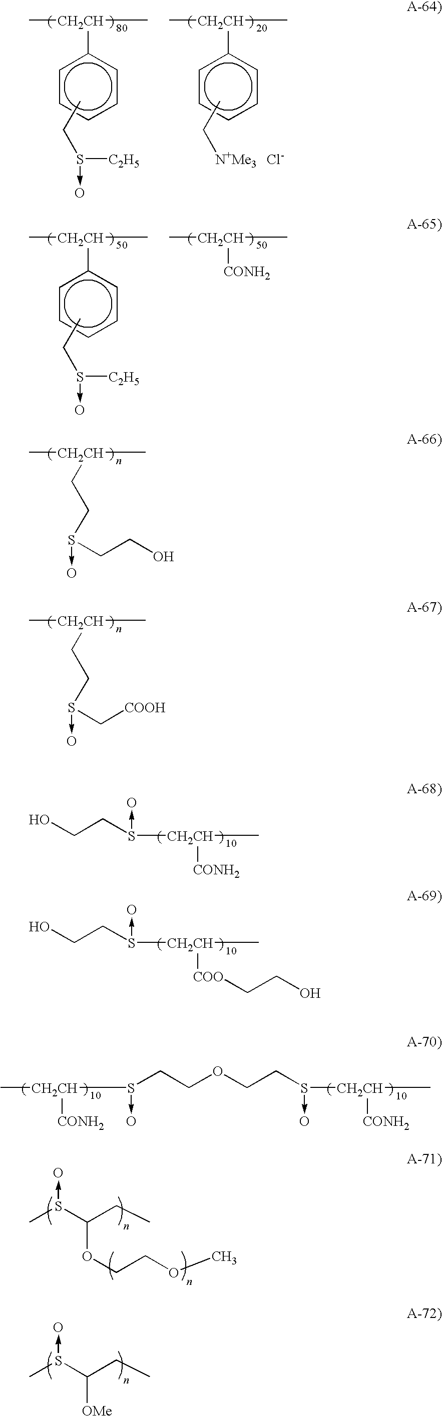

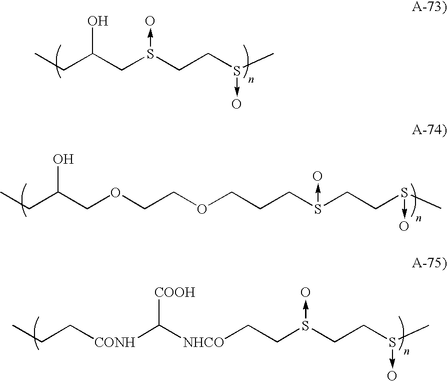

The amount of the sulfur-containing compound relative to silica in the second porous layer is preferably within a range of 0.5 to 5% by mass and, more preferably, within a range of 1 to 3% by mass. When the amount of the sulfur-containing compound is 0.5% by mass or more, the ozone resistance may become more favorable and the suppression of color change in a neutral color tone such as gray tone may not be affected, while, the amount of 5% by mass or less may be advantages in terms of prevention of lowering of image density, yellowing of image-receiving layer and deterioration (cracking) of coated surface.

In an exemplary embodiment of the second porous layer of the invention, the silica is gas-phase silica, the water-soluble aluminum compound is a basic polyaluminum chloride and the sulfur-containing compound is 3,6-dithio-1,8-octanediol.

(Binder)

The second porous layer of the invention may be configured using at least one type of binder, as in the first porous layer. Examples of the binder include a hydrophobic binder and a hydrophilic binder. A hydrophilic binder is preferred. Details of the binder are the same as those described for the first porous layer.

(Cross-Linking Agent)

The second porous layer of the invention may be configured using at least one type of cross-linking agent which cross-links the binder, as in the first porous layer. Details of the cross-linking agent are the same as those described for the first porous layer.

(Solvent)

In preparing a coating liquid for forming a second porous layer, a solvent is usually used.

As the solvent, water, organic solvent or a mixed solvent thereof may be used. Examples of the organic solvent that may be used for the coating liquid include an alcohol such as methanol, ethanol, n-propanol, isopropanol or methoxypropanol; a ketone such as acetone or methyl ethyl ketone; tetrahydrofuran; acetonitrile; ethyl acetate; and toluene.

(Others)

In the second porous layer of the invention, other components such as the known various additives which are the same as those for the first porous layer may be used in addition to the above-mentioned components within such an extent that they do not deteriorate the advantages of the invention.

In the second porous layer, the amount of a “cationic polymer containing an aromatic ring” in the second porous layer is no more than 4% by mass relative to silica contained in the second porous layer. The amount is preferably no more than 2% and, more preferably, 0% (zero %). When the second porous layer contains more than 4% of the cationic polymer containing an aromatic ring relative to silica contained in the second porous layer, the ozone resistance decreases and thus is not preferred.

In the inkjet recording medium of the invention, the pH of the coating liquid for forming a first porous layer and the pH of the coating liquid for the second porous layer are preferably within a range of 3.3 to 6.0, more preferably, within a range of 3.5 to 5.5. When the pH is within such a range, better ink-absorbing property, glossiness and uniformly coated surface may be achieved.

In an exemplary embodiment of the inkjet recording medium of the invention, in the first porous layer, the silica is a gas-phase silica and the cationic polymer containing an aromatic ring contains a structural unit represented by formula (A) (wherein R is methyl; R₁, R₂ and R₃ each independently is a methyl group, a ethyl group or a benzyl group; and J is a single bond or —CONH—), and, at least in one layer of the second porous layer, the silica is a gas-phase silica, the water-soluble aluminum compound is a basic polyaluminum chloride and the sulfur-containing compound is 3,6-dithio-1,8-octanediol.

When images are recorded using the inkjet recording medium of the invention, a recording method using an aqueous ink is preferred. An aqueous ink is a colored liquid containing a coloring agent, a solvent and other additive(s).

Examples of the coloring agent include a direct dye, an acidic dye, a basic dye, a reactive dye and a water-dispersible pigment or a water-soluble dye (such as a dye for foods) which have been known in the field of inkjet recording.

Examples of the solvent include water and various water-soluble organic solvents and preferable examples include an alcohol such as methyl alcohol, isopropyl alcohol, butyl alcohol, tert-butyl alcohol or isobutyl alcohol; an amide such as dimethylformamide or dimethylacetamide; a ketone or ketone alcohol such as acetone or diacetone alcohol; an ether such as tetrahydrofuran or dioxane; a polyalkylene glycol such as polyethylene glycol or polypropylene glycol; a polyhydric alcohol such as ethylene glycol, propylene glycol, butylene glycol, triethylene glycol, 1,2,6-hexanetriol, thiodiglycol, hexylene glycol, diethylene glycol, glycerol or triethanolamine; and a lower alkyl ether of polyhydric alcohol such as ethylene glycol methyl ether, diethylene glycol methyl (or ethyl)ether or triethylene glycol monobutyl ether. Among them, the particularly preferred ones are a polyhydric alcohol such as diethylene glycol, triethanolamine or glycerol and a lower alkyl ether of polyhydric alcohol such as triethylene glycol monobutyl ether.

Examples of the other additives include a pH-adjusting agent, a metal sequestering agent, an antifungal, a viscosity-adjusting agent, a surface tension adjusting agent, a moisturizer, a surfactant and a rust preventive agent.

As to physical properties of the aqueous ink, the surface tension at 20° C. is preferably within a range of 0.025 to 0.06 N/m and, more preferably, within a range of 0.03 to 0.05 N/m, in view of a good wetting to the inkjet recording medium.

Further, the pH of the aqueous ink in the inkjet recording medium of the invention is preferably 5 to 10 and, more preferably, 6 to 9.

### EXAMPLES

In the following, the present invention will be explained in further details with reference to the examples. However, the examples should not be construed as limiting the present invention. In the following Examples, as examples of the inkjet recording medium, the cases in which inkjet recording sheet is prepared will be mainly explained. Unless otherwise mentioned, the term “part(s)” means “part(s) by weight”.

### Example 1

### Preparation of Silica Dispersion for Upper Layer (Uppermost Layer)

Ion-exchange water (8,200 g), 300 g of a 40% by mass aqueous solution of the above-described exemplary compound P-1 (styrene-type cationic polymer) and 1,500 g of a gas-phase silica (AEROSIL 300, manufactured by Nippon Aerosil Co., Ltd.) were mixed and stirred for 20 minutes using a dissolver to prepare a crude dispersion of silica. After finishing the stirring, the crude silica dispersion was subjected to fine dispersing using a high-pressure dispersing machine (ULTIMIZER HJP 25005, manufactured by Sugino Machine Limited) to prepare a transparent silica dispersion containing 15% by mass of solid for the upper layer. At that time, the pressure and the discharging amount were 100 MPa and 600 g/minute, respectively. After that, the resulting silica dispersion was allowed to stand at 45° C. for 22 hours. An average particle size (average particle diameter of the secondary particles) of the silica dispersion after being allowed to stand for 22 hours was 0.11 μm.

The average particle size of the silica dispersion was measured by such a manner that the silica dispersion was diluted with ion-exchange water to an appropriate concentration and subjected to the measurement by a laser diffraction method using LA-920 (manufactured by Horiba) at a liquid temperature of 30° C.

—Preparation of Silica Dispersion for Lower Layer—

Ion-exchange water (8,370 g), 131 g of a silica dispersing agent (SHAROLL DC 902 P, manufactured by Daiichi Kogyo Seiyaku Co., Ltd.; polydiallyl dimethylammonium chloride) and 1,500 g of gas-phase silica (AEROSIL 300, manufactured by Nippon Aerosil Co., Ltd.) were mixed and stirred using a dissolver for 20 minutes to prepare a crude silica dispersion. After finishing the stirring, the crude silica dispersion was subjected to fine dispersing using a high-pressure dispersing machine (ULTIMIZER HJP 25005, manufactured by Sugino Machine Limited) to prepare a transparent silica dispersion containing 15% by mass of solid for the lower layer. At that time, pressure and discharging amount were 100 MPa and 600 g/minute, respectively. After that, the resulting silica dispersion was allowed to stand at 30° C. for 22 hours. An average particle size (average particle diameter of the secondary particles) of the silica dispersion after being allowed to stand for 22 hours was 0.1300 μm. Measurement of the average particle size was conducted by the same manner as mentioned above.

—Preparation of Coating Liquid for Ink-Receiving Layer (Porous Layer)—

(Preparation of a Coating Liquid for Forming an Upper Layer)

The silica dispersion for an upper layer (1,000 g), 89 g of a 7.5% by mass aqueous solution of boric acid, 320 g of a 59% by mass of AP-7 (manufactured by Japan Alcohol), 523 g of a 7% by mass aqueous solution of polyvinyl alcohol (PVA-235 (degree of saponification: 88%; average degree of polymerization: 3,500), manufactured by KURARAY CO., LTD.) and 12 g of a 10% by mass aqueous solution of surfactant (SUWANOL AM 2150, manufactured by Nikko Chemicals) were mixed and stirred for 10 minutes using a three-one motor to prepare a coating liquid for the upper layer (uppermost layer).

(Preparation of a Coating Liquid for Forming a Lower Layer)

The silica dispersion for a lower layer (1,000 g), 89 g of a 7.5% by mass aqueous solution of boric acid, 56 g of ALFINE 83 (manufactured by Taimei Chemicals Co., Ltd, aqueous solution of polyaluminum chloride), 355 g of a 59% by mass of AP-7 (manufactured by Nippon Alcohol KK), 523 g of a 7% by mass aqueous solution of polyvinyl alcohol (PVA-235 (degree of saponification: 88%; average degree of polymerization: 3,500), manufactured by KURARAY CO., LTD.), 12 g of a 10% by mass aqueous solution of surfactant (SUWANOL AM 2150, manufactured by Nikko Chemicals) and 83 g of a 1% by mass aqueous solution of naphthalenedisulfonic acid (Compound 1 shown below) were mixed and stirred for 10 minutes using a three-one motor to prepare a coating liquid for forming a lower layer.

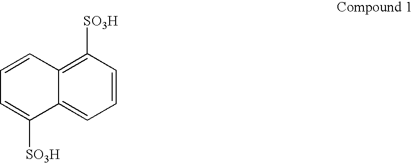

—Preparation of Support—

A 1:1 mixture of broadleaf bleached kraft pulp (LBKP) and needleleaf bleached sulfite pulp (NBSP) was beaten so that the freeness became 300 ml in terms of the Canadian Standard Freeness, thereby obtaining a pulp slurry. To this were added 0.5% by mass (to the pulp) of an alkylketene dimer as a sizing agent, as a strengthening agent, 1.0% by mass (to the pulp) of polyacrylamide, 2.0% by mass (to the pulp) of cationized starch and 0.5% by mass (to the pulp) of polyamide epichlorohydrin resin followed by diluting with water to prepare a 1% by mass slurry. The slurry was subjected to papermaking using a Fourdrinier paper machine so as to make the basis weight 170 g/m², followed by drying and adjusting the moisture, thereby obtaining a base paper for a polyethylene resin-coated paper. A polyethylene resin composition in which 10% of anatase-type titanium was uniformly dispersed in a resin of 100% low-density polyethylene having a density of 0.918 g/cm³ was melted at 320° C. and subjected to an extrusion coating at 200 m/minute onto the base paper so as to make the thickness 35 μm followed by subjecting to an extrusion coating using a cooling roll having a finely roughened surface. A blended resin composition containing 70 parts of a high-density polyethylene resin (density: 0.962 g/cm³) and 30 parts of a low-density polyethylene resin (density: 0.918) was melted at 320° C. in the same manner as described above, subjected to an extrusion coating onto the other surface to make the thickness 30 μm and then subjected to an extrusion coating using a cooling roll having a roughened surface.

The surface of the thus obtained polyolefin resin-coated paper was subjected to a high-frequency corona discharge treatment and then an undercoating layer having the following composition was formed such that the amount of gelatin was 50 mg/m², thereby obtaining a support.

—Undercoating Layer—

Lime-treated gelatin: 100 parts

Sulfosuccinic acid-2-ethylhexyl ester salt: 2 parts

Chromium alum: 10 parts

—Preparation of Inkjet Recording Sheet—

The thus obtained coating liquid for forming an upper layer and coating liquid for forming a lower layer were kept at 30° C. and applied simultaneously onto an undercoating layer of the support using a slide bead coating device. The coating liquid for forming an upper layer and the coating liquid for forming a lower layer were applied such that the amount of silica was 9 g/m² for each of the coating liquid for forming an upper layer and the coating liquid for forming a lower layer. After that, the coating film was set-dried for 2 minutes so that the surface temperature of the coated surface became 20° C. and then further dried at 80° C. for 10 minutes to give a porous membrane, thereby obtaining an inkjet recording sheet.

### Example 2

An ink-jet recording sheet of Example 2 was prepared in the same manner as in Example 1 except that, in the preparation of an coating liquid for forming a lower layer, 83 g of the 1% by mass aqueous solution of naphthalenedisulfonic acid was substituted with 4.2 g of the following thioether compound (Compound 2).

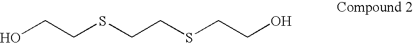

### Example 3

An ink jet recording sheet of Example 3 was prepared in the same manner as in Example 1 except that, in the preparation of the silica dispersion for a lower layer, SHAROLL DC 902 P (131 g) was substituted with 563 g of ALFINE 83 (manufactured by Taimei Chemicals Co., Ltd.; basic polyaluminum chloride) and 7,938 g of ion-exchange water.

### Example 4

An ink jet recording sheet of Example 4 was prepared in the same manner as in Example 2 except that, in the preparation of the silica dispersion for a lower layer, SHAROLL DC 902 P (131 g) was substituted with 563 g of ALFINE 83 (manufactured by Taimei Chemicals Co., Ltd; basic polyaluminum chloride) and 7,938 g of ion-exchange water.

### Example 5

### Preparation of Colloidal Silica Dispersion for Upper Layer (Uppermost Layer)

Ion-exchange water (2,200 g), 300 g of a 40% by mass aqueous solution of the above-described exemplary compound P-1 (styrene-type cationic polymer) and 7,500 g of colloidal silica dispersion (SNOWTEX OL, manufactured by Nissan Chemical Industries Ltd.) were mixed and stirred for 20 minutes using a dissolver to prepare a crude dispersion of silica. After finishing the stirring, the crude dispersion of silica was subjected to a fine dispersing using a high-pressure dispersing machine (ULTIMIZER HJP 25005, manufactured by Sugino Machine Limited) to prepare a transparent colloidal silica dispersion containing 15% by mass of solid. At that time, the pressure and the discharging amount were made 100 MPa and 600 g/minute, respectively. After that, the resulting silica dispersion was allowed to stand at 45° C. for 22 hours. An average particle size (average particle diameter of the secondary particles) of the silica dispersion after being allowed to stand for 22 hours was 0.05 μm.

The average particle size of the silica dispersion was measured by such a manner that the silica dispersion was diluted with ion-exchange water to an extent of an appropriate concentration and subjected to the measurement by a dynamic light scattering method using LB-500 (manufactured by Horiba) at a liquid temperature of 30° C.

—Preparation of Silica Dispersion for Lower Layer—

In the same manner as in Example 1, a transparent silica dispersion for a lower layer containing 15% by mass of solid was prepared. The pressure and the discharging amount upon preparation were made 100 MPa and 600 g/minute, respectively and the silica dispersion obtained thereafter was allowed to stand at 30° C. for 22 hours. An average particle size (average particle diameter of the secondary particles) of the silica dispersion after being allowed to stand for 22 hours was 0.1300 μm. The average particle size was measured in the same manner as described above.

—Preparation of Coating Liquid for Forming Ink-Receiving Layer (Porous Layer)—

(Preparation of a Coating Liquid for Forming an Upper Layer)

The colloidal silica dispersion (1,000 g) for an upper layer, 89 g of a 7.5% by mass aqueous solution of boric acid, 320 g of 59% by mass of AP-7 (manufactured by Japan Alcohol), 523 g of a 7% by mass aqueous solution of polyvinyl alcohol (PVA-235 (degree of saponification: 88%; average degree of polymerization: 3,500) manufactured by KURARAY CO., LTD.) and 12 g of a 10% by mass aqueous solution of surfactant (SUWANOL AM 2150, manufactured by Nikko Chemicals) were mixed and stirred using a three-one motor, thereby obtaining a coating liquid for forming an upper layer (uppermost layer).

(Preparation of a Coating Liquid for Forming a Lower Layer)

By the same manner as in Example 1, a coating liquid for forming a lower layer was prepared.

—Preparation of Inkjet Recording Sheet—

The above-prepared coating liquid for forming an upper layer and coating liquid for forming a lower layer were kept at 30° C. and were simultaneously applied onto an undercoating layer of the support using a slide bead coating device. The coating liquid for forming an upper layer and the coating liquid for forming a lower layer were applied so that the amount of silica was made 1 g/m² for the coating liquid for forming an upper layer and 18 g/m² for the coating liquid for forming a lower layer. After that, the coating film was set-dried for 2 minutes so that the surface temperature of the coated surface became 20° C. and then further dried at 80° C. for 10 minutes to give a porous membrane, thereby an inkjet recording sheet was prepared.

### Examples 6 to 8

Inkjet recording sheets of Examples 6 to 8 were prepared in the same manner as in Example 1 except that, in the preparation of the silica dispersion for a upper layer, the 40% by mass of aqueous solution of exemplary compound P-1 (styrene-type cationic polymer) was changed to a 40% by mass aqueous solution of any of the above-described exemplary compounds P-2 to P-4 (styrene-type cationic polymers).

### Example 9

An inkjet recording sheet of Example 9 was prepared in the same manner as in Example 1 except that, in dispersing the gas-phase silica in the preparation of the silica dispersion for a lower layer, 41 g of methionine sulfoxide was further added, and the 1% by mass aqueous solution of naphthalene disulfonic acid was not added in the preparation of the coating liquid for forming a lower layer.

### Example 10

An inkjet recording sheet of Example 10 was prepared in the same manner as in Example 1 except that the 40% by mass aqueous solution of exemplary compound P-1 (styrene-type cationic polymer) that was used in the preparation of the silica dispersion for an upper layer was further added in an amount of 11.3 g to a coating liquid for forming a lower layer.

### Comparative Example 1

An inkjet recording sheet of Comparative Example 1 was prepared in the same manner as in Example 1 except that, in the preparation of the silica dispersion for an upper layer, 300 g of the 40% by mass aqueous solution of exemplary compound P-1 (styrene-type cationic polymer) was substituted with 131 g of SHAROLL DC 902 P (manufactured by Daiichi Kogyo Seiyaku Co., Ltd.; polydiallyldimethylammonium chloride) and 8,369 g of ion-exchange water.

### Comparative Example 2

An inkjet recording sheet of Comparative Example 2 was prepared in the same manner as in Comparative Example 1 except that, in the preparation of the silica dispersion for a lower layer, 131 g of SHAROLL DC 902 P was substituted with 563 g of ALFINE 83 (manufactured by Taimei Chemicals Co., Ltd; basic polyaluminum chloride) and 7,938 g of ion-exchange water.

### Comparative Example 3

An inkjet recording sheet of Comparative Example 3 was prepared in the same manner as in Example 1 except that, in the preparation of a coating liquid for forming a lower layer, naphthalenedisulfonic acid was not added.

### Comparative Example 4

An inkjet recording sheet of Comparative Example 4 was prepared in the same manner as in Example 1 except that, in the preparation of a coating liquid for forming a lower layer, ALFINE 83 was not added.

### Comparative Example 5

An inkjet recording sheet of Comparative Example 5 was prepared in the same manner as in Example 1 except that the 40% by mass aqueous solution of exemplary compound P-1 (styrene-type cationic polymer) that was used in the preparation of silica dispersion for an upper layer was further added in an amount of 18.8 g (5% to silica) to a coating liquid for forming a lower layer.

(Evaluation)

The inkjet recording sheets prepared in the above Examples and Comparative Examples were evaluated as follows.

—1. Ozone Resistance—

An inkjet printer PM-G-800 (manufactured by Seiko Epson Corporation) installed with genuine ink was used, with respect to each inkjet recording sheet, solid image of magenta (M), solid image of cyan (C) and solid image of black (BK) were recorded to prepare image samples, and image densities (D_{M}⁰, D_{C}⁰ and D_{BK}⁰) of solid images M, C and BK were measured using a reflection densitometer GRETAG SPECTROLINO SPM-50 (manufactured by Gretag Macbeth) under the condition where visual angle was 2°, light source was D50 and no filter was used. Next, the resulting sample image was stored for 24 hours under the atmosphere of 23° C./60% RH where an ozone concentration was 5 ppm and then the image densities (D_{M}¹, D_{C}¹ and D_{BK}¹) of solid images M, C and BK immediately after the storage were measured by the same manner as above. On the basis of the image density (D⁰) before the storage and the image density (D¹) after the storage for each color, the density residue ratio (D) for each of magenta, black and cyan was calculated from the following formula. The more the % value, the better the ozone resistance. Result of the calculation is shown in Table 1.

D(%)=(D¹/D⁰)×100

—Changes in Color Tone (Measurement of ΔE)—

An inkjet printer PM-A820 (manufactured by Seiko Epson Corporation) was used and a gray solid image was recorded on each inkjet recording sheet. At that time, the gradation of the image data was adjusted so that a gray density measured by GRETAG SPECTROLINO SPM-50 (manufactured by Gretag Macbeth; visual angle: 2°; light source: D50; no filter) became 1.7. Immediately after printing and after 4 hours from the printing, the solid gray image was subjected to the measurement of L*a*b* using a spectrophotometer SPECTROLINO (manufactured by Gretag Macbeth) under the condition where visual angle was 2°, light source was F8 and no filter was used and then a color difference (ΔE) was determined from each measured value and used as an index for evaluating the changes in color tone. The evaluation was conducted from the value of the color difference in accordance with the following evaluation criteria.

<Evaluation Criteria>

A: ΔE<2; Changes in color tone were almost unable to be recognized
B: 2≦ΔE<4; Although changes in color tone were noted, they were not so noticeable
C: 4≦ΔE<7; Changes in color tone were considerably noted.
D: ΔE≧7; Changes in color tone were significant

TABLE 1

| | Upper Layer | | Lower Layer | | | | | | |
|---|---|---|---|---|---|---|---|---|---|
| | | Aromatic Ring- | Silica | Water- | Sulfur- | Ozone Resistance (%) | | | Gray |
| | | Containing | Dispersing | Soluble Aluminum | Containing | Magenta | | Black | Part |
| | Silica | Cationic Polymer | Agent | Compound | Compound | (M) | Cyan (C) | (BK) | ΔE |
| Example 1 | GP | SC P-1 | PDDAC | PAC | NDSA | 80 | 85 | 90 | 0.5 |
| Example 2 | GP | SC P-1 | PDDAC | PAC | TEC | 85 | 85 | 90 | 0.6 |
| Example 3 | GP | SC P-1 | PAC | PAC | NDSA | 85 | 86 | 92 | 0.8 |
| Example 4 | GP | SC P-1 | PAC | PAC | TEC | 88 | 86 | 92 | 0.8 |
| Example 5 | CS | SC P-1 | PDDAC | PAC | NDSA | 80 | 85 | 90 | 0.5 |
| Example 6 | GP | SC P-2 | PDDAC | PAC | NDSA | 80 | 85 | 90 | 0.4 |
| Example 7 | GP | SC P-3 | PDDAC | PAC | NDSA | 80 | 85 | 90 | 0.6 |
| Example 8 | GP | SC P-4 | PDDAC | PAC | NDSA | 80 | 85 | 90 | 0.3 |
| Example 9 | GP | SC P-1 | PDDAC | PAC | MS | 80 | 85 | 90 | 0.5 |
| Example 10 | GP | SC P-1 | PDDAC | PAC | NDSA | 75 | 80 | 88 | 0.4 |
| Comparative | GP | non-aromatic type *1 | PDDAC | PAC | NDSA | 85 | 88 | 93 | 4.5 |
| Example 1 | | | | | | | | | |
| Comparative | GP | non-aromatic type *1 | PAC | PAC | NDSA | 85 | 86 | 93 | 3.0 |
| Example 2 | | | | | | | | | |
| Comparative | GP | SC P-1 | PDDAC | PAC | — | 80 | 70 | 75 | 0.5 |
| Example 3 | | | | | | | | | |
| Comparative | GP | SC P-1 | PDDAC | — | NDSA | 65 | 75 | 70 | 0.5 |
| Example 4 | | | | | | | | | |
| Comparative | GP | SC P-1 | PDDAC | PAC | NDSA | 60 | 70 | 70 | 0.3 |
| Example 5 | | | | | | | | | |

*1: polydiallyldimethylammonium chloride (non-aromatic type)
GP: gas-phase silica
CS: colloidal silica
SC: styrene-type cationic polymer
PDDAC: polydiallyldimethylammonium chloride
PAC: polyaluminum chloride
NDSA: naphthalenedisulfonic acid
TEC: thioether compound
MS: methionine sulfoxide

As shown in Table 1, in the Examples, ozone resistance in various colors was improved, particularly in cyan, and, in addition, changes in color tone in a gray portion could be suppressed. In contrast, in the Comparative Examples, balancing of both ozone resistance and prevention of color change could not be achieved.

In accordance with the invention, it is possible to provide an inkjet recording medium in which changes in color tone (color changes) in a neutral color such as a gray tone are prevented and in which ozone resistance is also excellent.

Hereinafter, exemplary embodiments of the present invention will be listed. However, the present invention is not limited to the following exemplary embodiments.

<1> An inkjet recording medium, comprising:

a resin-coated paper in which both sides of a base paper are coated with a polyolefin resin;

a first porous layer disposed as an uppermost layer that is positioned farthest from the resin-coated paper, the first porous layer containing silica and a cationic polymer containing an aromatic ring; and

at least one second porous layer disposed between the first porous layer and the resin-coated paper, the at least one second porous layer containing silica, a water-soluble aluminum compound and a sulfur-containing compound, and the content of a cationic polymer containing an aromatic ring in the at least one second porous layer being no more than 4% by mass relative to the silica contained in the at least one second porous layer.

<2> The inkjet recording medium according to <1>, wherein, in at least one layer selected from the group consisting of the first porous layer and the at least one second porous layer, the silica is gas-phase silica or colloidal silica.

<3> The inkjet recording medium according to <1> or <2>, wherein the sulfur-containing compound is a thioether compound.

<4> The inkjet recording medium according to any one of <1> to <3>, wherein the sulfur-containing compound is a compound containing a sulfo group.

<5> The inkjet recording medium according to <4>, wherein the compound containing a sulfo group is a sulfonic acid or a salt thereof.

<6> The inkjet recording medium according to any one of <1> to <5>, wherein the water-soluble aluminum compound is polyaluminum chloride.

<7> The inkjet recording medium according to any one of <1> to <6>, wherein, in the at least one second porous layer, the silica is contained in a dispersed state prepared using the water-soluble aluminum compound.

<8> The inkjet recording medium according to any one of <1> to <7>, wherein the cationic polymer containing an aromatic ring in the first layer has a structural unit represented by the following formula (A):

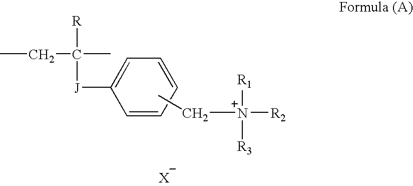

wherein, in formula (A), R is a hydrogen atom or an alkyl group; R₁, R₂ and R₃ each independently represent an alkyl group or a benzyl group; J represents a single bond or a divalent organic group; and X⁻ represents an anionic group.

All publications, patent applications, and technical standards mentioned in this specification were herein incorporated by reference to the same extent as if each individual publication, patent application, or technical standard was specifically and individually indicated to be incorporated by reference.

What is claimed is:

1. An inkjet recording medium, comprising:
a resin-coated paper in which both sides of a base paper are coated with a polyolefin resin;
a first porous layer disposed as an uppermost layer that is positioned farthest from the resin-coated paper, the first porous layer containing silica and a cationic polymer containing an aromatic ring; and
at least one second porous layer disposed between the first porous layer and the resin-coated paper, the at least one second porous layer containing silica, a water-soluble aluminum compound and a sulfur-containing compound, and the content of a cationic polymer containing an aromatic ring in the at least one second porous layer being no more than 4% by mass relative to the silica contained in the at least one second porous layer.

2. The inkjet recording medium according to claim 1, wherein, in at least one layer selected from the group consisting of the first porous layer and the at least one second porous layer, the silica is gas-phase silica or colloidal silica.

3. The inkjet recording medium according to claim 1, wherein the sulfur-containing compound is a thioether compound.

4. The inkjet recording medium according to claim 1, wherein the sulfur-containing compound is a compound containing a sulfo group.

5. The inkjet recording medium according to claim 4, wherein the compound containing a sulfo group is a sulfonic acid or a salt thereof.

6. The inkjet recording medium according to claim 1, wherein the water-soluble aluminum compound is polyaluminum chloride.

7. The inkjet recording medium according to claim 1, wherein, in the at least one second porous layer, the silica is contained in a dispersed state prepared using the water-soluble aluminum compound.

8. The inkjet recording medium according to claim 1, wherein the cationic polymer containing an aromatic ring in the first porous layer has a structural unit represented by the following formula (A): 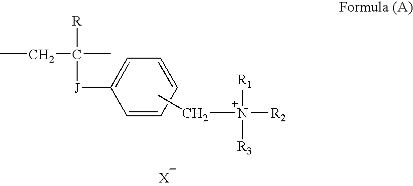
wherein, in formula (A), R is a hydrogen atom or an alkyl group; R₁, R₂ and R₃ each independently represent an alkyl group or a benzyl group; J represents a single bond or a divalent organic group; and X⁻ represents an anionic group.
